(19) United States
(12) Patent Application Publication
(10) Pub. No.: US 2009/0114077 A1
(43) Pub. Date: May 7, 2009

(54) Wind instrument provided with a resonating buffer

(76) Inventor: Ching-Shyan Yen, Taichung County (TW)

Correspondence Address: Ching-Shyan Yen, P.O. Box 2-42 Tanzih, Taichung County, 42799, TW

(21) Appl. No.: 11/982,645

(22) Filed: Nov. 5, 2007

(51) Int. Cl. G10D 7/00

(52) U.S. Cl. 84/380 R

(57) ABSTRACT

A wind instrument provided with a resonating buffer comprises a wind tube including a mouthpiece provided on the forwardmost end thereof, an outlet mounted on the rearwardmost end thereof, and a curved portion arranged between the mouthpiece and the outlet thereof, at least one resonating buffer attached between the curved portion and the outlet of the wind tube. So that the sound waves become gentle and clam and flow forward to the outlet, thereby eliminating interruption and overcoming cacophony.

### BACKGROUND OF THE INVENTION

1. Field of the Invention

The present invention relates to a wind instrument, and more particularly to a wind instrument provided with a resonating buffer so that the sound waves may become gentle and clam instead of interrupting with each other, and then flow forward to the outlet, thus overcoming cacophony.

2. Description of the Prior Arts

In playing a straight-tube wind instrument, since sound waves are not stopped by the inner wall of the wind tube, an interruption will not occur. While during playing a bended wind instrument, such as a saxophone or a trumpet, an interruption will occur because the sound waves are stopped by the inner wall of the curved portion of the wind tube, thus causing confused sound waves and cacophony.

As shown in FIG. 6, for example, the bended wind instrument comprises a wind tube 1, including a curved portion 11 formed thereon and having inner and outer walls 111, 112 both arranged therein. Therefore, when playing the bended wind instrument, sound waves impact the outer wall 112 to cause interruption and cacophony.

The present invention has arisen to mitigate and/or obviate the afore-described disadvantages.

### SUMMARY OF THE INVENTION

The primary object of the present invention is to provide a wind instrument provided with a resonating buffer that the sound waves may become gentle and claim instead of interruption with each other and flow forward to the outlet, thus overcoming cacophony.

In accordance with one aspect of the present invention, there is provided a wind instrument provided with a resonating buffer comprising a wind tube and at least one resonating buffer. It is preferable that at least one fixing device is disposed in the wind instrument for securely affixing the resonating buffer onto the wind tube.

The wind tube includes a mouthpiece provided on the forwardmost end thereof, an outlet mounted on the rearwardmost end thereof, and a curved portion arranged between the mouthpiece and the outlet thereof and having inner and outer walls formed therein respectively.

The resonating buffer is attached between the curved portion and the outlet of the wind tube, and also may be secured onto the curved portion directly. Preferably, the resonating buffer may be disposed onto the same side as the outer wall of the wind tube.

The fixing device is utilized to mount the resonating buffer onto the wind tube, wherein it is arranged between the curved portion and the outlet of the wind tube, and the resonating buffer is affixed onto the fixing device. It is preferable that the fixing device may be a clamper on which a plurality of fasteners are fixed. The clamper is retained between the curved portion and the outlet of the wind tube, and the resonating buffer includes a fixed portion formed thereon. By way of the fasteners, the fixed portion is firmly retained onto the fixing device. Likewise, the wind tube may be integrally formed with the fixing device, and then the resonating buffer is attached onto the fixing device. Furthermore, the wind tube, the resonating buffer, and the fixing device may be integrally formed together as well.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a partial perspective diagram illustrating the components of a wind instrument provided with a resonating buffer according to the present invention;

FIG. 1A is an amplified perspective diagram illustrating the partial components of the wind instrument provided with a resonating buffer according to FIG. 1;

FIG. 2 is a perspective diagram illustrating the assembly of the wind instrument provided with a resonating buffer according to FIG. 1;

FIG. 3 is a perspective diagram illustrating the flowing state of sound waves of the present invention when played;

FIG. 4 is a partial perspective diagram illustrating the exploded components of a wind instrument provided with a resonating buffer according to another embodiment of the present invention;

FIG. 5 is a perspective diagram illustrating the assembly of the wind instrument provided with a resonating buffer according to FIG. 1;

FIG. 6 is a perspective diagram illustrating the flowing state of sound waves of a prior art wind instrument when played.

### DETAILED DESCRIPTION OF THE PREFERRED EMBODIMENT

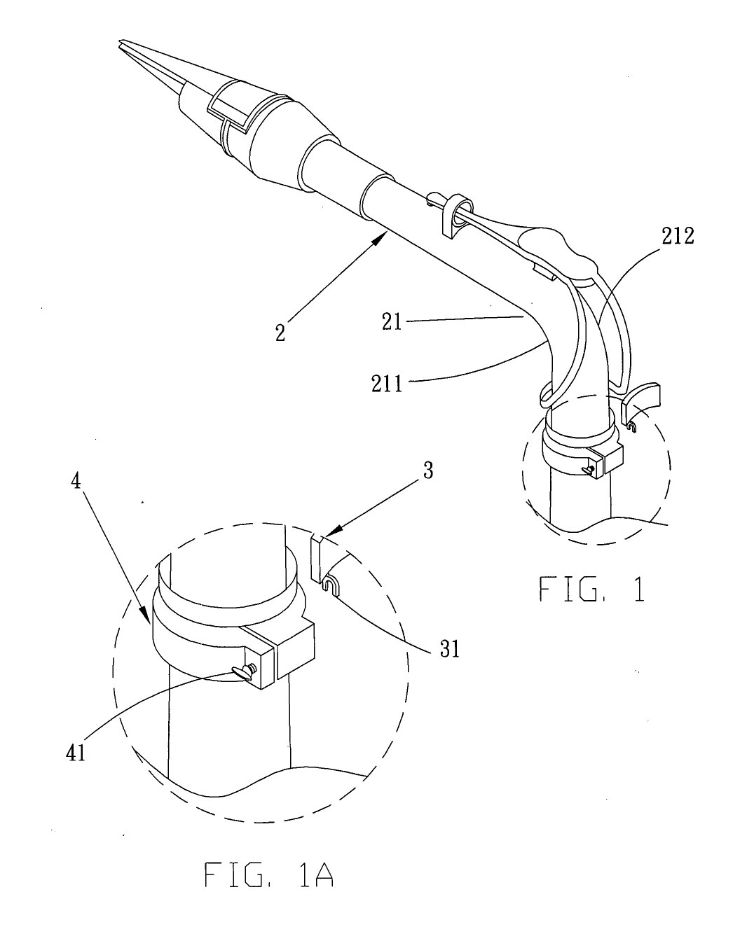

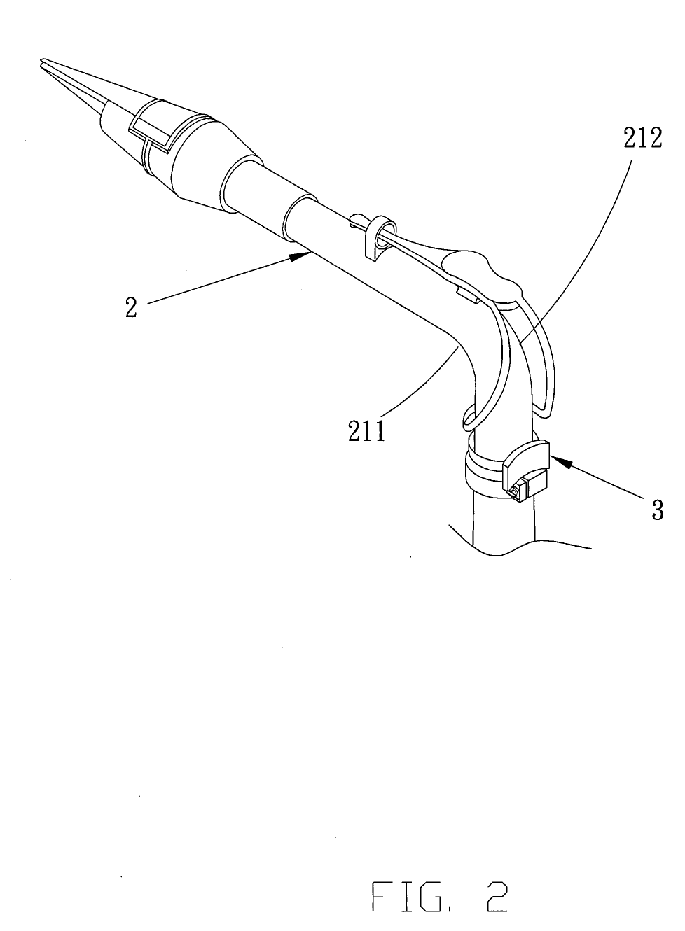

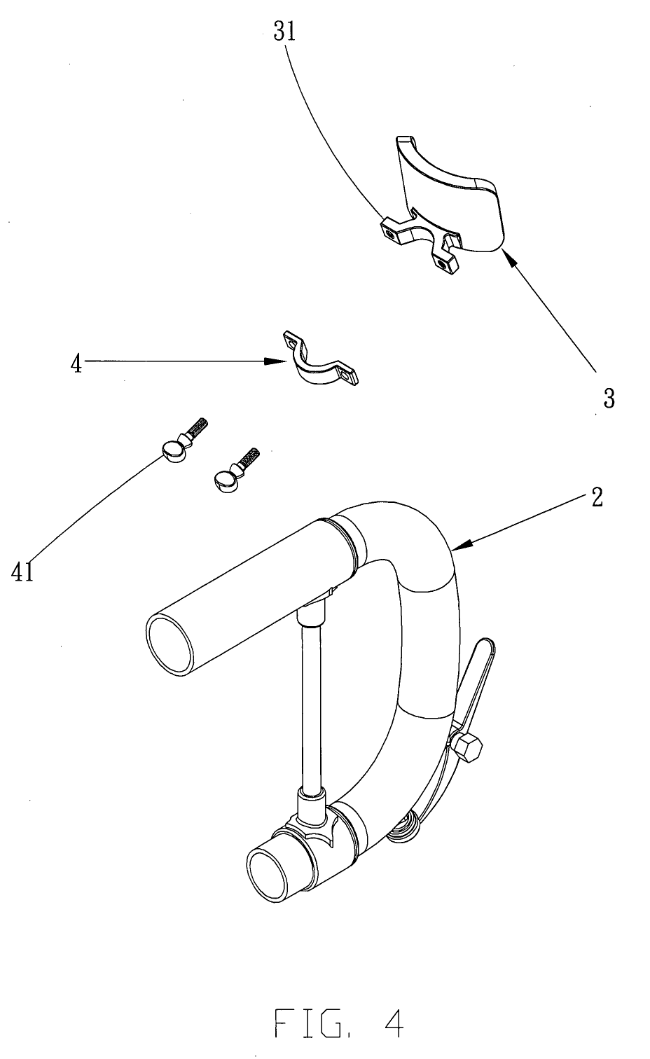

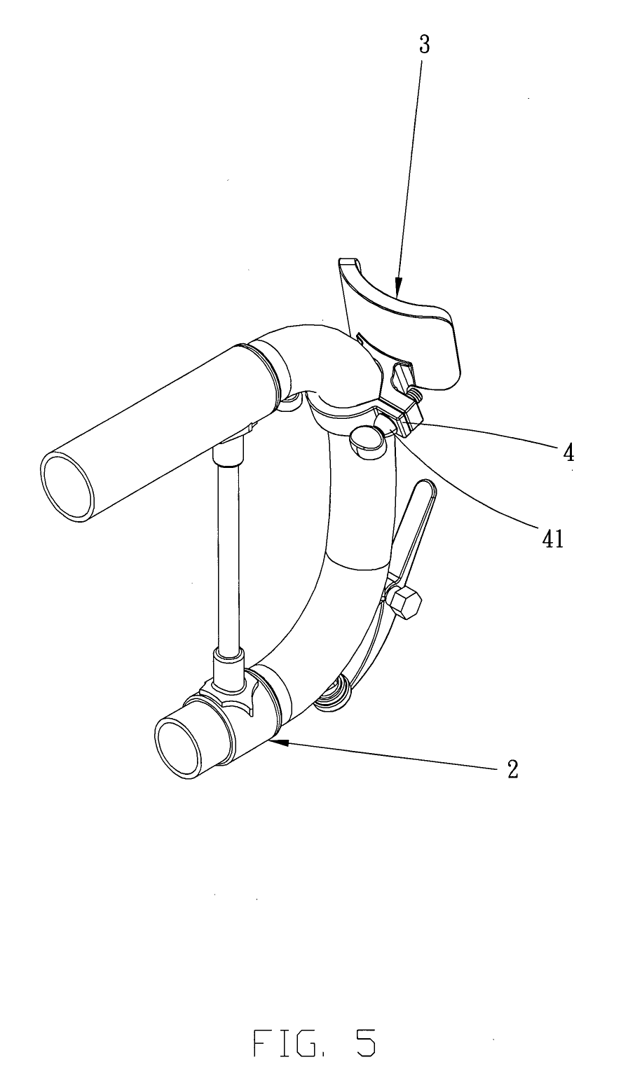

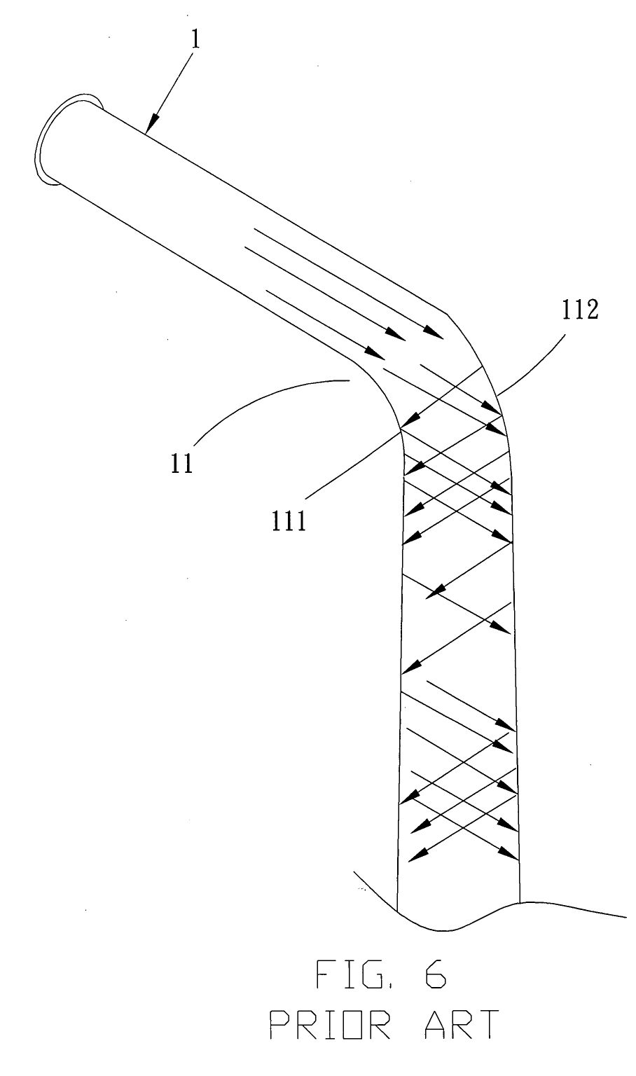

Referring to FIGS. 1-5, a wind instrument provided with a resonating buffer in accordance with the present invention comprises a wind tube 2 and at least one resonating buffer 3. It is preferable that at least one fixing device 4 is disposed in the wind instrument for securely affixing the resonating buffer 3 onto the wind tube 2.

The wind tube 2 includes a mouthpiece 201 provided on the forwardmost end thereof, an outlet 202 mounted on the rearwardmost end thereof, and a curved portion 21 arranged between the mouthpiece 201 and the outlet 202 thereof and having inner and outer walls 211, 212 formed therein respectively.

The resonating buffer 3 is attached between the curved portion 21 and the outlet 202 of the wind tube 2, and also may be secured onto the curved portion 21 directly. Preferably, the resonating buffer 3 may be disposed onto the same side as the outer wall 212 of the wind tube 2.

The fixing device 4 is utilized to mount the resonating buffer 3 onto the wind tube 2, wherein it is arranged between the curved portion 21 and the outlet 202 of the wind tube 2, and the resonating buffer 3 is affixed onto the fixing device 4. It is preferable that the fixing device 4 may be a clamper on which a plurality of fasteners 41 are fixed. The clamper is retained between the curved portion 21 and the outlet 202 of the wind tube 2, and the resonating buffer 3 includes a fixed portion 31 formed thereon. By way of the fasteners 41, the fixed portion 31 is firmly retained onto the fixing device 4. The wind tube 2 may be integrally formed with the fixing device 4, and then the resonating buffer 3 is attached onto the fixing device 4. Furthermore, the wind tube 2, the resonating buffer 3, and the fixing device 4 may be integrally formed together as well.

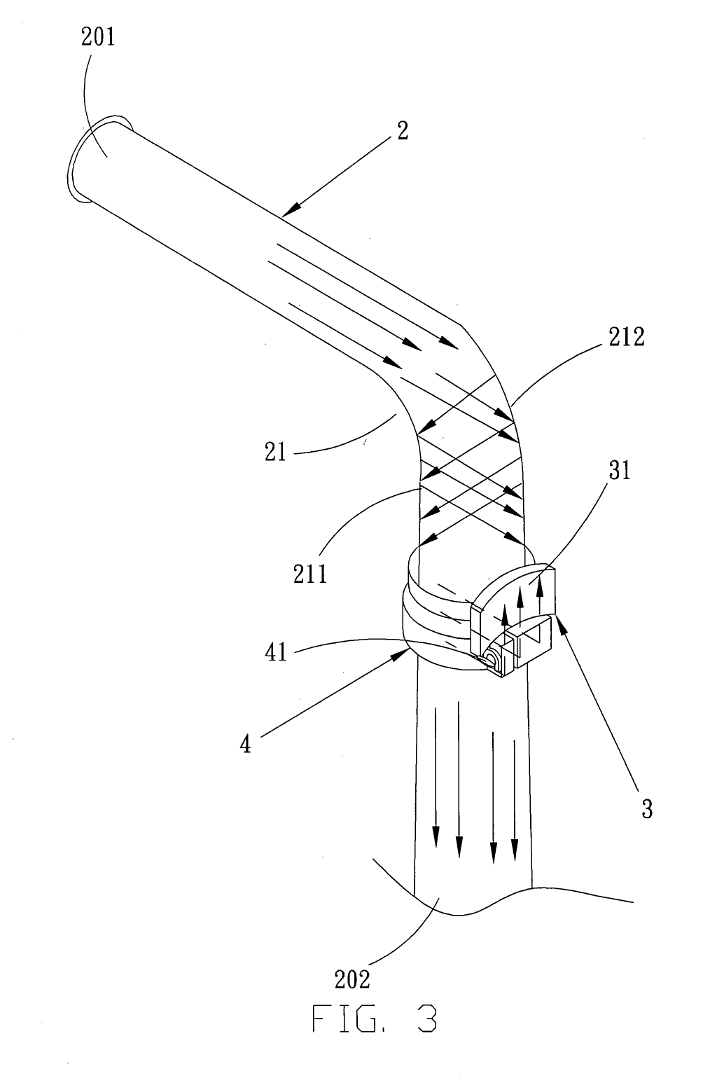

As illustrated in FIG. 3, during playing the wind instrument, sound waves flow forward from the mouthpiece 201 to the outlet 202, yet because of the curved portion 21, the sound waves impact the outer wall 212 to cause an interrupting. Thereafter, by using the fixing device 4 having at least one resonating buffer 3 secured thereon, the sound waves become gentle and clam instead of interruption with each other and flow forward to the outlet 202, thus overcoming cacophony.

It is to be noted that the resonating buffer 3 may be formed in any desired shape on the basis of the player's requirement, since different shapes of resonating buffers 3 may achieve different resonation and for influencing the playing of the wind instrument.

The invention is not limited to the above embodiment but various modifications thereof may be made. It will be understood by those skilled in the art that various changes in form and detail may be made without departing from the scope and spirit of the present invention.

What is claimed is:

1. A wind instrument provided with a resonating buffer comprising:
a wind tube including a mouthpiece provided on the forwardmost end thereof, an outlet mounted on the rearwardmost end thereof, and a curved portion arranged between said mouthpiece and said outlet thereof;
at least one resonating buffer attached between said curved portion and said outlet of said wind tube;

2. The wind instrument provided with a resonating buffer as claimed in claim 1, wherein the mounting location of said resonating buffer includes said curved portion of said wind tube.

3. The wind instrument provided with a resonating buffer as claimed in claim 1, wherein said curved portion includes inner and outer walls formed therein respectively, and said resonating buffer may be disposed onto the same side as said outer wall of said wind tube.

4. The wind instrument provided with a resonating buffer as claimed in claim 1, wherein the wind instrument further includes said fixing device arranged between said curved portion and said outlet of said wind tube, and said resonating buffer is affixed onto said fixing device.

5. The wind instrument provided with a resonating buffer as claimed in claim 4, wherein said fixing device may be a clamper on which a plurality of fasteners are fixed, said clamper is retained between said curved portion and said outlet of said wind tube, and said resonating buffer includes a fixed portion formed thereon, and by way of said fasteners, said fixed portion is firmly retained onto said fixing device.

6. The wind instrument provided with a resonating buffer as claimed in claim 5, wherein said fasteners of said fixing device may be clamping elements for securely retaining said wind tube.

7. The wind instrument provided with a resonating buffer as claimed in claim 4, wherein said wind tube may be integrally formed with said fixing device, and then said resonating buffer is attached onto said fixing device.

8. The wind instrument provided with a resonating buffer as claimed in claim 4, wherein said wind tube, said resonating buffer, and said fixing device may be integrally formed together as well.
